(19) United States
(12) Patent Application Publication
(10) Pub. No.: US 2004/0058702 A1
(43) Pub. Date: Mar. 25, 2004

(54) Mobile radio telephone comprising an associative user interface

(76) Inventor: Christian Schnabel, Berlin (DE)

Correspondence Address: MORRISON & FOERSTER LLP, 1650 TYSONS BOULEVARD, SUITE 300, MCLEAN, VA, 22102, US

(21) Appl. No.: 10/296,812

(22) PCT Filed: Mar. 16, 2001
(86) PCT No.: PCT/DE01/01108

(51) Int. Cl. H04B 7/15

(52) U.S. Cl. 455/550.1; 455/11.1

(57) ABSTRACT

The invention relates to a mobile radio telephone terminal (5) comprising a display device (10) for displaying display elements (15, 20, 25, 30), each of which representing a user-selectable device function of the mobile radio telephone terminal. Said mobile radio telephone terminal also comprises control elements (35, 40, 45 and 50) with which each one of the represented device functions can be activated. Said display elements are spatially arranged on the display device such that one control element is assigned to each displayed display element. The aim of the invention is to enable a particularly quick and simple operation of the mobile radio telephone terminal. To this end, the invention provides that the mobile radio telephone terminal is configured for detecting, with regard to each individual device function, how often the respective device functions are activated, and the display elements for the most frequently activated device functions are preferably displayed if there are more activatable device functions provided than there are control elements available.

The invention relates to a mobile radio telephone terminal comprising a display device for displaying display elements which in each case represent a user-selectable device function of the mobile radio telephone terminal, and comprising operating elements by means of which in each case one of the device functions represented can be activated, the display elements being spatially arranged on the display device in such a manner that in each case one operating element is associated with each display element displayed.

Such a mobile radio telephone terminal is described in the operating instructions for the Siemens mobile radio telephone C25. This mobile radio telephone terminal has menu control, which means that the device functions are combined into groups of functions. Each group of functions is represented by one menu item of the menu. Starting with a higher-level first menu, the menu—When the operating elements are correspondingly operated by the user—then branches into submenus from which it may branch further into further submenus in each case when activated. This branching and branching further is repeated until a single one of the device functions available on the device has been unambiguously determined and selected. Navigation through the menus is made possible by means of the operating elements which are implemented as acknowledgement keys.

The invention is based on the object of specifying a mobile radio telephone terminal in which device functions can be selected and activated in a simpler and more rapid manner than in the mobile radio telephone terminal previously known.

According to the invention, this object is achieved in a mobile radio telephone terminal of the type initially specified in that the mobile radio telephone terminal is designed in such a manner that it detects with regard to each individual device function how often the respective device functions are activated, and displays with preference the display elements for the most frequently activated device functions if there is a greater number of activatable device functions available than there are operating elements.

An essential advantage of the mobile radio telephone terminal according to the invention consists in that it can be operated in a particularly rapid and simple manner by the user because the device functions most frequently used by him are offered to him for activation or, respectively, displayed to him with preference. In concrete terms, this advantage is achieved in the mobile radio telephone terminal according to the invention in that it is detected with regard to each individual device function how often the respective device functions are activated. The device functions most frequently called up are then displayed on the display device.

However, so that the user is also able to activate those device functions which are activated less frequently and, therefore, are not displayed by the display device—for example because of the limited number of existing operating elements or for reasons of space on the display device, it is considered to be advantageous according to the invention if the mobile radio telephone terminal has an input device by means of which the device functions not shown can be displayed and/or activated by the user.

The input device can be implemented in a particularly simple and inexpensive manner if it is formed by the numerical keypad existing in any case in mobile radio telephone terminals because, in this case, no additional key elements or the like need to be provided which minimizes the production costs in the mobile radio telephone terminal according to the invention.

The mobile radio telephone terminal according to the invention can be operated in a particularly rapid and simple manner if the numerical keypad of the mobile radio telephone terminal is suitable for inputting text and the mobile radio telephone terminal is designed in such a manner that, when a text input is present, the display device displays that device function whose function designation best corresponds to the text input; this is because this design of the mobile radio telephone terminal according to the invention virtually creates an “associative” user interface. In concrete terms, the mobile radio telephone terminal compares the respective text input with the function designations of the available device functions and then displays on the display device the display elements for those device functions whose function designation best corresponds to the text input. For example, the associative user interface can be designed in such a manner that after each letter of the text input has been input, a comparison is made as to which of the function designations of the device functions best correspond to the text input, the device functions thus selected then being displayed with their display elements on the display device of the mobile radio telephone terminal. If, for example, four device functions can be represented with their display elements on the display device, the four device functions, the function designations of which best correspond to the text input, would then be represented with their graphical display elements on the display device after a text has been input by means of the input device. Using the operating elements, the user can then subsequently select the device function which he wishes to activate; if, however, the device function required by him is not represented by means of a display element on the display device he can ensure, by correcting the text input or by inputting other letters, that the display on the display device changes in such a way that the device function required by him appears with the respective display element on the display device. Once this has been achieved, he can call up the required device function by operating the associated operating element.

In a development of the mobile radio telephone terminal according to the invention, it is considered to be advantageous if the input device is formed by a voice recognition device capable of recognizing voice commands and the mobile radio telephone terminal is designed in such a manner that, when a voice command is present, the display device displays the display element for those device functions whose function designations best correspond to the voice command. In this development of the mobile radio telephone terminal according to the invention, the device functions not displayed can be displayed and/or activated by a voice input as a result of which a particularly high degree of operating convenience is achieved.

To explain the invention,

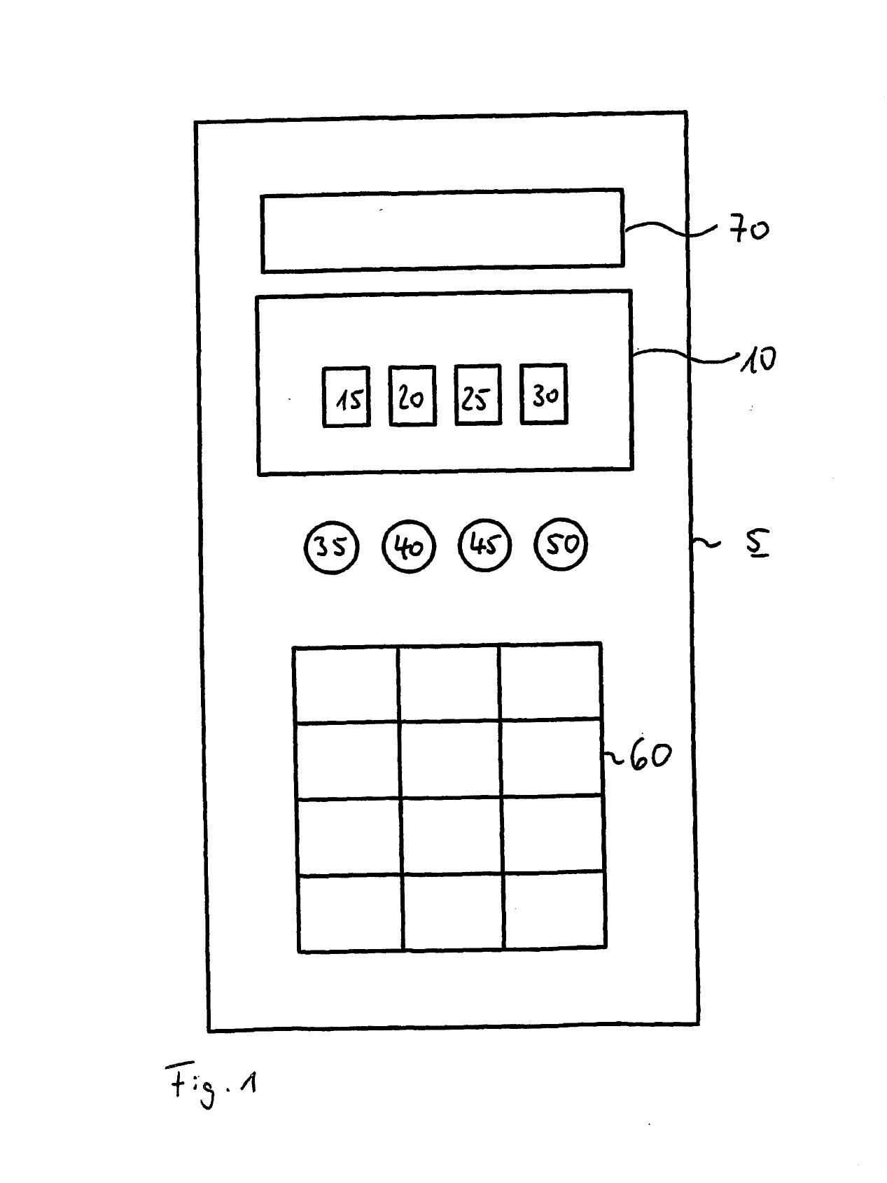

FIG. 1 shows an exemplary embodiment of a mobile radio telephone terminal according to the invention and

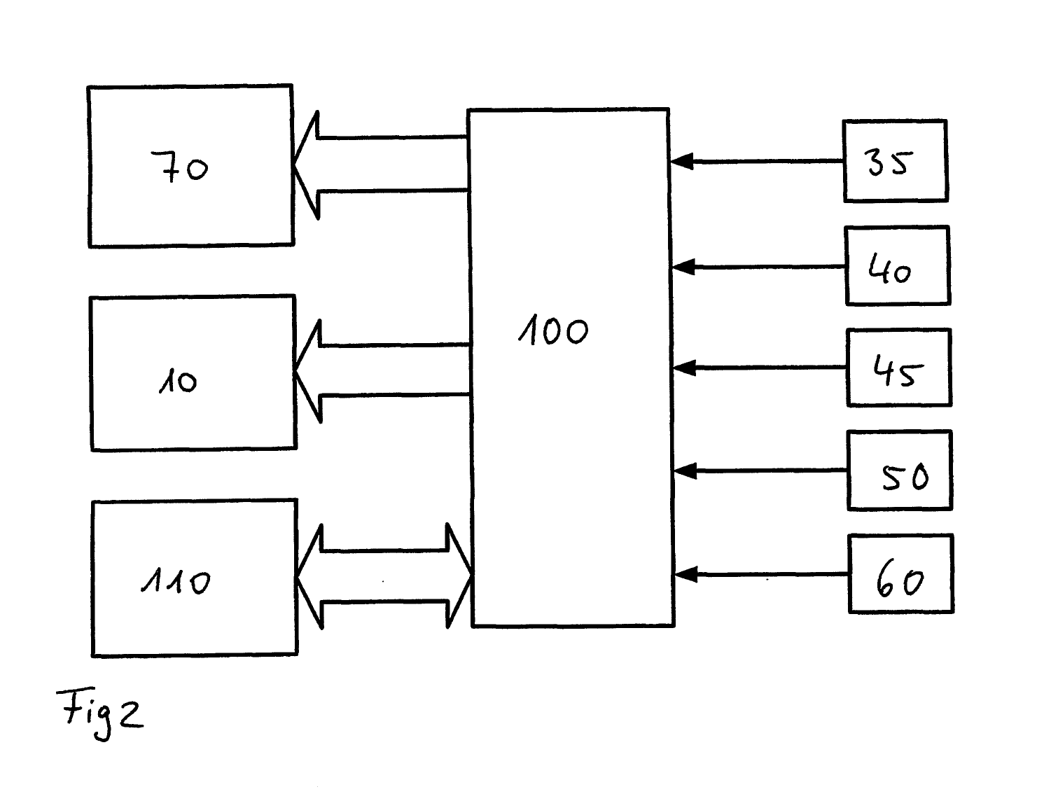

FIG. 2 shows the mobile radio telephone terminal according to FIG. 1 in a more detailed representation.

FIG. 1 shows a mobile radio telephone terminal 5 which can be, for example, a mobile telephone operating in the DECT, GSM or Bluetooth standard. This mobile radio telephone terminal 5 has a display device 10 by means of which the graphical display elements 15, 20, 25 and 30—called icons in the technical language can be displayed. In concrete terms, the graphical display elements 15, 20, 25 and 30 are used for displaying in each case a user-selectable device function of the mobile radio telephone terminal 5. In addition, the mobile radio telephone terminal 5 has operating elements 35, 40, 45 and 50 which are spatially allocated in each case one display element 15, 20, 25 and 30 in FIG. 1. The respective associated device function is activated by operating or activating one of the operating elements 35, 40, 45 or 50.

To ensure a clear representation in FIG. 1, the other components normally present in mobile radio telephone terminals, such as loudspeaker, microphone, hook switch keys, callback key, on/off key, etc., are not shown.

The mobile radio telephone terminal 5 has a control device, not shown in FIG. 1, which detects with respect to each individual device function, and stores in an associated memory device, how often the respective device functions are activated.

When the mobile radio telephone terminal 5 is operated, it will happen that the device is brought into an operating state in which more than four device functions can be selected and activated by the user, that is to say more device functions than there are operating elements available for activation; this is because only four operating elements are provided in the mobile radio telephone terminal 5. For example, when the mobile radio telephone terminal 5 is newly switched on, virtually all functions of the mobile radio telephone terminal will be available whereas in another operating mode or operating state of the mobile radio telephone terminal 5, only a very restricted number of device functions can be activatable.

To provide for a particularly simple and rapid operation of the mobile radio telephone terminal 5, in the case where there are more device functions available than there are operating elements, the mobile radio telephone terminal 5 is designed in such a manner that it displays the display elements (icons) 15, 20, 25 and 30 for the most frequently activated device functions because it can be expected that one of these most frequently activated device functions will be activated again; the less frequently activated device functions are thus initially not displayed on the display device 10.

To make it possible that those device functions which are not represented on the display device can also be selected, the mobile radio telephone terminal 5 has a numerical keypad 60 as input device by means of which normally the telephone numbers can be input into the mobile radio telephone terminal 5; however, this numerical keypad 60 is also suitable for inputting letters, thus for inputting text, in a manner known per se. Using this numerical keypad 60, it is possible to input a text in the mobile radio telephone terminal 5, namely a text which designates the required device function. Thus, using this numerical keypad 60, the operator can input the corresponding function designation of the device function for those device functions for which no display element is displayed. So that the input text can also be displayed to the user, the mobile radio telephone terminal 5 is equipped with a separate display 70 which displays the user text input. Using the control device, not shown in FIG. 1, the text input is compared with the function designations of all device functions available for the mobile radio telephone terminal 5, stored in the abovementioned memory device, and those display elements 15, 20, 25 and 30 on the display device 10 whose device function or function designation best corresponds to the text input on the display 70, are displayed; thus, the memory device can be considered to be a type of “device function database”. If the user of the mobile radio telephone, after having input the text, finds that the device function required by him is displayed as display element on the display device 10, he can select or, respectively, activate the required device function by activating the respective associated operating element 35, 40, 45 or, respectively, 50.

The mobile radio telephone terminal 5 can be designed in such a manner that when one of the operating elements 35, 40, 45 and 50 is operated, the control device, not shown in FIG. 1, of the mobile radio telephone terminal 5 first specifies on the display device 10 or the display 70 the device function in question. This can be achieved in that the corresponding brief description of the respective device function is inserted. Following this—that is to say when the respective operating element is also operated—the device function is then actually activated.

In the above representation of the mobile radio telephone terminal 5, it has been assumed that the numerical keypad 60 is used for activating or, respectively, selecting device functions not shown; instead, it is also conceivable that the device function not shown is reached by the user by means of a corresponding voice input; naturally, this assumes the existence of a corresponding voice recognition function in the mobile radio telephone terminal 5.

FIG. 2 shows the mobile radio telephone 5 according to FIG. 1 in greater detail. The control device already mentioned above has the reference symbol 100; the control device 100 is connected to the memory device, also already mentioned above, having the reference symbol 110. In addition, FIG. 2 also shows the operating elements 35, 40, 45 and 50 and the numerical keypad 60, the inputs of which are connected to the control device 100.

At the output end, the display device 10 and the display 70 are connected to the control device 100.

The control device 100 can be formed, for example, by a microcomputer which is programmed in accordance with the description of the functions of the mobile radio telephone terminal 5 explained in detail in connection with FIG. 1; the memory device 110 can be formed, for example, by a semiconductor memory element.

The mobile radio telephone 5 can also be designed with downloading capability; i.e. the software or the control program for the control device 100 is modified, for example, via the radio link set up by the mobile radio telephone terminal. Thus, e.g., device functions not previously existing can be downloaded and the type or appearance of the display elements (icons) can be changed for individual users. The control device 100 then stores the software or, respectively, the control program in the memory device 110.

1. A mobile radio telephone terminal (5)
comprising a display device (10) for displaying display elements (15, 20, 25, 30) which in each case represent a user-selectable device function of the mobile radio telephone terminal, and
comprising operating elements (35, 40, 45 and 50) by means of which in each case one of the device functions represented can be activated,
the display elements being spatially arranged on the display device in such a manner that in each case one operating element is associated with each display element displayed,
characterized in that
the mobile radio telephone terminal is designed in such a manner
that it detects with respect to each individual device function how often the respective device functions are activated, and
displays with preference the display elements for the most frequently activated device functions if there is a greater number of activatable device functions available than there are operating elements.

2. The mobile radio telephone terminal as claimed in claim 1, characterized in that
it has an input device (60) by means of which the device functions not shown can be displayed and/or activated by the user.

3. The mobile radio telephone terminal as claimed in claim 2, characterized in that
the input device is formed by a numerical keypad (60) of the mobile radio telephone terminal.

4. The mobile radio telephone terminal as claimed in claim 3, characterized in that
the numerical keypad of the mobile radio telephone terminal is suitable for inputting text and
the mobile radio telephone terminal is designed in such a manner that, when a text input is present, the display device displays that device function whose function designation best corresponds to the text input.

5. The mobile radio telephone terminal as claimed in claim 2, characterized in that
the input device is formed by a voice recognition device capable of recognizing voice commands and
the mobile radio telephone terminal is designed in such a manner that, when a voice command is present, the display device displays the display element for those device functions whose function designations best correspond to the voice command.
